(19) United States
(12) Patent Application Publication
(10) Pub. No.: US 2026/0268066 A1
(43) Pub. Date: Sep. 10, 2026

(54) ARTIFICIAL INTELLIGENCE-BASED TEXT PROCESSING METHOD AND APPARATUS, AND COMPUTER-READABLE STORAGE MEDIUM

(71) Applicant: TENCENT TECHNOLOGY (SHENZHEN) COMPANY LIMITED, Shenzhen (CN)

(72) Inventor: Yong HU, Shenzhen (CN)

(21) Appl. No.: 19/659,686

(22) Filed: Apr. 27, 2026

Related U.S. Application Data
(63) Continuation of application No. PCT/CN2024/139267, filed on Dec. 13, 2024.

(30) Foreign Application Priority Data
Jan. 19, 2024 (CN) 202410078244.5

(51) Int. Cl. G06F 40/166; G06N 3/0499; G06N 3/08; G06V 30/19

(52) U.S. Cl. CPC G06F 40/166; G06N 3/0499; G06N 3/08; G06V 30/1916; G06V 30/1918

(57) ABSTRACT

This application provides an artificial intelligence-based text processing method and apparatus, an electronic device, a computer program product, and a computer-readable storage medium. The method includes obtaining a first integrated text, the first integrated text being obtained by correcting a first original text; concatenating the first integrated text and the first original text, to obtain a concatenated text; performing multi-dimensional evaluation on the concatenated text, to obtain an evaluation result corresponding to each dimension, the multi-dimensional evaluation comprising at least two of the following: semantic evaluation, grammatical evaluation, and formatting evaluation; and fusing the evaluation results of at least two of the dimensions, to obtain a corrected evaluation result of the first integrated text.

### RELATED APPLICATIONS

This application is a continuation of PCT Application No. PCT/CN2024/139267, filed on Dec. 13, 2024, which in turn claims priority to Chinese Patent Application No. 202410078244.5, filed with the China National Intellectual Property Administration on Jan. 19, 2024, which are both incorporated herein by reference in their entirety.

### FIELD OF THE TECHNOLOGY

This application relates to the field of computer technologies, and in particular, to an artificial intelligence-based text processing method and apparatus, an electronic device, a computer-readable storage medium, and a computer program product.

### BACKGROUND OF THE DISCLOSURE

Artificial intelligence (AI) refers to theories, methods, technologies, and application systems that use digital computers or machines controlled by digital computers to simulate, extend, and expand human intelligence, perceive the environment, acquire knowledge, and use the knowledge to obtain optimal results.

In the related art, an automatic text rewriting function is provided for performing grammatical correction and text completion on a text, thereby implementing correction of the text. However, text rewriting effect is difficult to quantify. Certain automated evaluation solutions require a rewrite text and a reference answer to be provided, and perform evaluation by comparing the degree of lexical overlap between the rewrite text and the reference answer. The solutions rely on the reference answer, and cannot truly and objectively reflect an actual rewriting effect. In the related art, although certain automated evaluation solutions use models to improve the speed of an evaluation process, their evaluation accuracy is low.

### SUMMARY

Embodiments of this application provide an artificial intelligence-based text processing method and apparatus, an electronic device, a computer-readable storage medium, and a computer program product, to improve both accuracy and efficiency of text rewriting quality evaluation.

Technical solutions in the embodiments of this application are implemented as follows.

An embodiment of this application provides an artificial intelligence-based text processing method, performed by an electronic device. The method includes obtaining a first integrated text, the first integrated text being obtained by correcting a first original text; concatenating the first integrated text and the first original text, to obtain a concatenated text; performing multi-dimensional evaluation on the concatenated text, to obtain an evaluation result corresponding to each dimension, the multi-dimensional evaluation comprising at least two of the following: semantic evaluation, grammatical evaluation, and formatting evaluation; and fusing the evaluation results of at least two of the dimensions, to obtain a corrected evaluation result of the first integrated text.

An embodiment of this application provides an electronic device, including: a memory, configured to store computer-executable instructions; and a processor, configured to implement the artificial intelligence-based text processing method according to the embodiments of this application when executing the computer-executable instructions stored in the memory.

An embodiment of this application provides a non-transitory computer-readable storage medium, having computer-executable instructions stored therein, the instructions being configured for implementing, when executed by a processor, the artificial intelligence-based text processing method according to the embodiments of this application.

The embodiments of this application have following beneficial effects.

The first integrated text obtained by correcting the first original text is obtained, the first integrated text and the first original text are concatenated to obtain the concatenated text, and the first integrated text and the first original text are inputted as a whole, thereby improving data processing efficiency. The multi-dimensional evaluation is performed on the concatenated text, to obtain the evaluation result corresponding to each dimension. The multi-dimensional evaluation includes at least two of the following: semantic evaluation, grammatical evaluation, and formatting evaluation, so that a plurality of evaluation dimensions can be provided to meet different evaluation requirements. The evaluation results of at least two of the dimensions are fused, to obtain the corrected evaluation result of the first integrated text. Through fusion of the evaluation results of the plurality of dimensions, accuracy of text correction quality evaluation can be improved.

### BRIEF DESCRIPTION OF THE DRAWINGS

FIG. 1 is a schematic architectural diagram of an artificial intelligence-based text processing system according to an embodiment of this application.

FIG. 2 is a schematic structural diagram of a server according to an embodiment of this application.

FIG. 3A is a schematic flowchart of an artificial intelligence-based text processing method according to an embodiment of this application.

FIG. 3B is an schematic flowchart 1 of an artificial intelligence-based text processing method according to an embodiment of this application.

FIG. 3C is an schematic flowchart 2 of an artificial intelligence-based text processing method according to an embodiment of this application.

FIG. 3D is a schematic flowchart 3 of an artificial intelligence-based text processing method according to an embodiment of this application.

FIG. 4 is a schematic flowchart of an evaluation model training method according to an embodiment of this application.

FIG. 5A is a schematic diagram of a text rewriting interface for rewriting in semantic and grammatical dimensions according to an embodiment of this application.

FIG. 5B is a schematic diagram of a text rewriting interface for rewriting in semantic, grammatical, and formatting dimensions according to an embodiment of this application.

FIG. 6 is an overall architectural diagram of a text rewriting evaluation solution according to an embodiment of this application.

FIG. 7 is a schematic structural diagram of an evaluation model according to an embodiment of this application.

### DESCRIPTION OF EMBODIMENTS

To make objectives, technical solutions, and advantages of this application clearer, the following describes this application in further detail with reference to the accompanying drawings. The described embodiments are not to be considered as a limitation on this application. All other embodiments obtained by a person of ordinary skill in the art without creative efforts fall within the protection scope of this application.

“Some embodiments” involved in the following descriptions describes a subset of all embodiments. However, “some embodiments” may be the same subset or different subsets of all the embodiments, and may be combined with each other when there is no conflict.

In the following descriptions, the terms “first”, “second”, and “third” are merely intended to distinguish between similar objects and do not indicate a specific sequence of the objects. A specific order or sequence of the terms “first”, “second”, and “third” may be interchanged if permitted, so that the embodiments of this application described herein can be implemented in an order other than that illustrated or described herein.

In the embodiments of this application, the term “module” or “unit” refers to a computer program having a predetermined function or a part of the computer program, which works together with other relevant parts to achieve a predetermined objective, and may be all or partially implemented by using software, hardware (for example, a processing circuit or a memory), or a combination thereof. Similarly, a processor (or a plurality of processors or memories) may be configured to implement one or more modules or units. In addition, each module or unit may be a part of an overall module or unit including a function of the module or unit.

Unless otherwise defined, all technical and scientific terms used in the embodiments of this application have the same meanings as those generally understood by a person skilled in the art. The terms used in the embodiments of this application are merely intended to describe the objectives of the embodiments of this application, and are not intended to limit this application.

Before the embodiments of this application are further described in detail, descriptions are made on the terms involved in the embodiments of this application, and the terms involved in the embodiments of this application are applicable to the following explanations.

(1) Large language model (LLM): It is an artificial intelligence model, aimed at understanding and generating human languages. The LLMs are trained on a large amount of text data and may perform a wide range of tasks, including text summarization, translation, sentiment analysis, and the like. The LLMs are characterized by their large scale, encompassing billions to trillions of parameters, which help them to learn complex patterns in language data.

(2) Text rewriting: Text rewriting refers to rewriting operations performed on an inputted original text without changing its original meaning, including correcting errors (such as spelling errors or grammatical errors), making expression more fluent, and making formatting clearer.

(3) Pre-trained model (PTM): It is also referred to as a foundation model or a large model, which refers to a deep neural network (DNN) having a large quantity of parameters. The model is trained on massive unlabeled data. A function approximation capability of the DNN having a large quantity of parameters is used to enable the PTM to extract a general feature from the data. Through technologies such as fine-tuning, parameter-efficient fine-tuning (PEFT), and prompt-tuning, the PTM can be adapted to downstream tasks. Therefore, the pre-trained model can achieve an ideal effect in a few-shot scenario or a zero-shot scenario.

(4) Natural language processing (NLP): It is an important direction in the fields of computer science and artificial intelligence. It studies various theories and methods that can implement effective communication between people and computers by using natural languages. The natural language processing relates to natural language, that is, languages used by people in daily life, and the natural language processing is closely related to linguistic studies. An important technology of model training in the field of artificial intelligence, namely, the pre-trained model, is developed from a large language model (LLM) in the field of NLP. After fine-tuning, the large language model can be widely applied to downstream tasks. The natural language processing technologies generally include technologies such as text processing, semantic understanding, machine translation, robot question-answering, and knowledge graph.

Given a rewrite text and a reference answer, evaluation is often performed by comparing degree of lexical overlap between the rewrite text and the reference answer, calculating metrics such as bilingual evaluation understudy (BLEU) and recall-oriented understudy for gisting evaluation (ROUGE).

When implementing the embodiments of this application, the applicant finds that the related art has the following defects.

Certain automated evaluation method requires less time and lower cost, but has a poor effect. The calculation of these metrics heavily depends on reference answers, but there is no standard answer for text rewriting. Therefore, calculating the metrics based on only one (or several) of the reference answers cannot objectively reflect an actual rewriting effect.

An artificial intelligence-based text processing method provided in the embodiments of this application relates to the natural language processing technology in the field of artificial intelligence and the pre-trained model technology in the field of large models, and is specifically described by using the following embodiments.

The embodiments of this application provide an artificial intelligence-based text processing method and apparatus, an electronic device, a computer-readable storage medium, and a computer program product, to improve both accuracy and efficiency of text rewriting quality evaluation.

Applications of the electronic device according to the embodiments of this application are described below. The device according to the embodiments of this application may be implemented as various types of user terminals such as a notebook computer, a tablet computer, a desktop computer, a set-top box, a mobile device (for example, a mobile phone, a portable music player, a personal digital assistant, a dedicated messaging device, or a portable gaming device), a smartphone, a smart speaker, a smartwatch, a smart television, and an in-vehicle terminal, or may be implemented as a server. An application in which the electronic device is implemented as a server is described below.

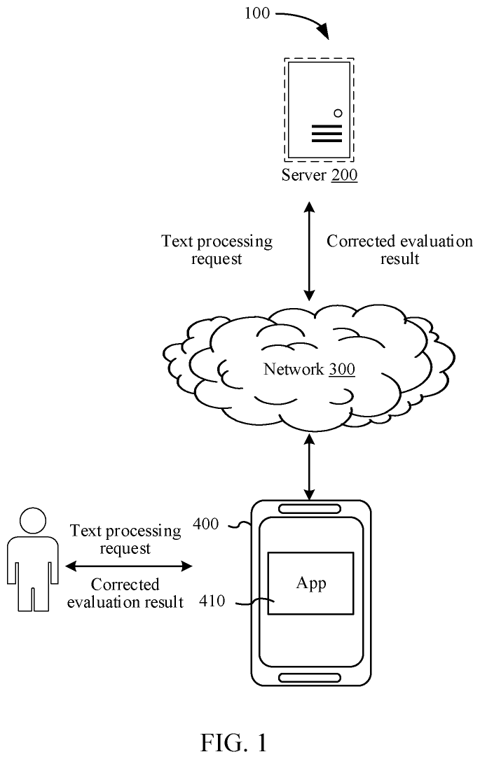

FIG. 1 is a schematic architectural diagram of an artificial intelligence-based text processing system 100 according to an embodiment of this application. To support an artificial intelligence-based text processing application, a terminal 400 is connected to a server 200 through a network 300. The network 300 may be a wide area network, a local area network, or a combination thereof.

The terminal 400 is configured to obtain a text processing request. For example, the user terminal 400 generates the text processing request through a graphical interface 410 of the terminal 400. The server 200 is configured to: obtain a first integrated text based on the text processing request, the first integrated text being obtained by correcting a first original text; concatenate the first integrated text and the first original text, to obtain a concatenated text; perform multi-dimensional evaluation on the concatenated text, to obtain an evaluation result corresponding to each dimension, the multi-dimensional evaluation including at least two of the following: semantic evaluation, grammatical evaluation, and formatting evaluation; fuse the evaluation results of at least two of the dimensions, to obtain a corrected evaluation result of the first integrated text; and feed back the corrected evaluation result to the terminal 400.

In some embodiments, the server 200 may be an independent physical server, a server cluster or distributed system including a plurality of physical servers, or a cloud server providing a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The terminal 400 may be a smartphone, a tablet computer, a notebook computer, a desktop computer, a smart speaker, a smartwatch, an in-vehicle terminal, or the like, but is not limited thereto. The terminal and the server may be connected directly or indirectly in a wired or wireless communication manner. This is not limited in this embodiment of this application.

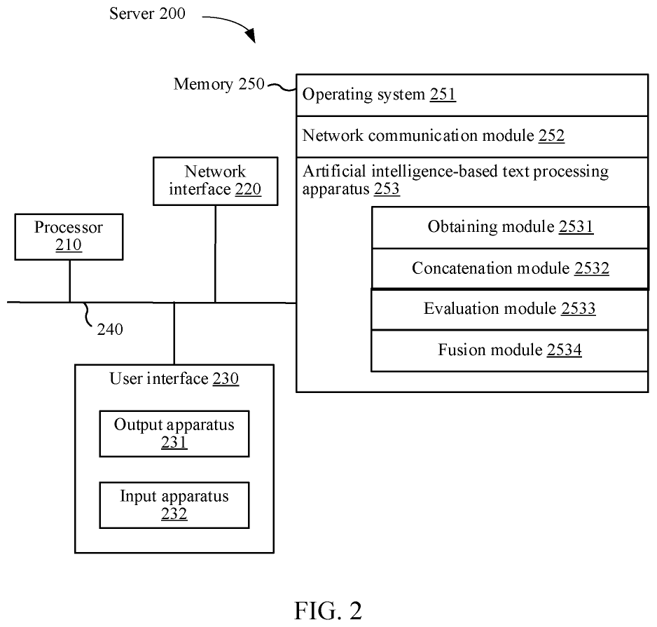

FIG. 2 is a schematic structural diagram of a server 200 according to an embodiment of this application. The server 200 shown in FIG. 2 includes: at least one processor 210, a memory 250, at least one network interface 220, and a user interface 230. Components in the server 200 are coupled together through a bus system 240. The bus system 240 is configured to implement connection and communication between the components. In addition to a data bus, the bus system 240 further includes a power bus, a control bus, and a state signal bus. However, for clear description, all types of buses in FIG. 2 are marked as the bus system 240.

The processor 210 may be an integrated circuit chip having a signal processing capability, for example, a general-purpose processor, a digital signal processor (DSP), or another programmable logic device, discrete gate, transistor logical device, or discrete hardware component. The general-purpose processor may be a microprocessor, any conventional processor, or the like.

The user interface 230 includes one or more output apparatuses 231 that enable presentation of media content, including one or more speakers and/or one or more visual display screens. The user interface 230 further includes one or more input apparatuses 232, including user interface components that facilitate user input, such as a keyboard, a mouse, a microphone, a touchscreen display, a camera, and other input buttons and controls.

The memory 250 may be a removable memory, a non-removable memory, or a combination thereof. A hardware device includes a solid memory, a hard disk drive, an optical disk drive, and the like. In one embodiment, the memory 250 includes one or more storage devices physically located away from the processor 210.

The memory 250 includes a volatile memory or a non-volatile memory, or may include both a volatile memory and a non-volatile memory. The non-volatile memory may be a read only memory (ROM), or the volatile memory may be a random-access memory (RAM). The memory 250 described in this embodiment of this application is intended to include a memory of any suitable type.

In some embodiments, the memory 250 can store data to support various operations. An example of the data includes a program, a module, a data structure, or a subset or superset thereof. Example descriptions are provided below.

An operating system 251 includes a system program configured for processing various basic system services and performing hardware-related tasks, for example, a framework layer, a core library layer, and a drive layer, and is configured to implement various basic services and process hardware-based tasks.

A network communication module 252 is configured to reach another electronic device via one or more (wired or wireless) network interfaces 220. For example, the network interface 220 includes: Bluetooth, wireless fidelity (Wi-Fi), universal serial bus (USB), and the like.

In some embodiments, the apparatus provided in this embodiment of this application may be implemented in a software manner. FIG. 2 shows an artificial intelligence-based text processing apparatus 253 stored in the memory 250. The artificial intelligence-based text processing apparatus 253 may be software in a form such as a program or a plug-in, which includes the following software modules: an obtaining module 2531, a concatenation module 2532, an evaluation module 2533, and a fusion module 2534. These modules are logical, and therefore, may be randomly combined or further divided according to their respective functions. Functions of the modules are described below.

In some embodiments, the terminal or the server may implement the artificial intelligence-based text processing method according to the embodiments of this application by executing various computer-executable instructions or a computer program. For example, the computer-executable instructions may be microprogram-level commands, machine instructions, or software instructions. The computer program may be a native program or a software module in an operating system, may be a native application (APP), that is, a program that only needs to be installed on an operating system to run, such as an instant messaging APP, or may be a mini program that can be embedded into any APP, that is, a program that only needs to be downloaded into a browser environment to run. In conclusion, the computer-executable instructions may be instructions in any form, and the computer program may be an application, a module, or a plug-in in any form.

The artificial intelligence-based text processing method according to the embodiments of this application is described with reference to exemplary applications and implementations of the server according to this embodiment of this application.

In the following examples of text processing, text rewriting is used as an example for description. A person skilled in the art can apply, according to understanding of the following, the artificial intelligence-based text processing method according to the embodiments of this application to evaluation of other text processing including text rewriting.

The following describes the artificial intelligence-based text processing method according to the embodiments of this application in detail with reference to the accompanying drawings. The artificial intelligence-based text processing method according to the embodiments of this application may be separately performed by the terminal 400 or the server 200 in FIG. 1, or may be cooperatively performed by the terminal 400 and the server 200 in FIG. 1.

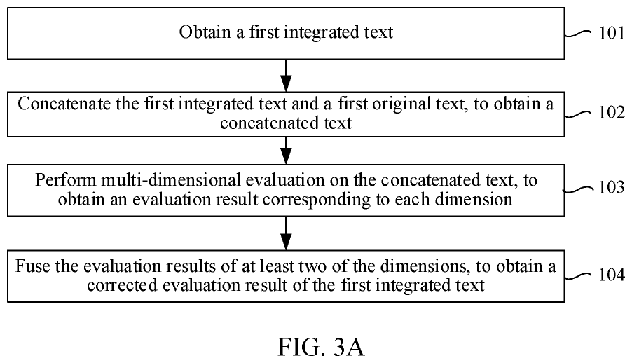

Descriptions are provided below by using an example in which the server 200 in FIG. 1 separately performs the artificial intelligence-based text processing method according to the embodiments of this application. FIG. 3A is a schematic flowchart of an artificial intelligence-based text processing method according to an embodiment of this application. Descriptions are provided with reference to operation 101 to operation 104 shown in FIG. 3A.

Operation 101: Obtain a first integrated text.

In an example, the first integrated text is obtained by correcting a first original text. A user constructs the first original text, uses the first original text as an input, and performs a text processing operation on the first original text by using a text processing model, for rewriting (correcting) the text. In this embodiment of this application, the text processing operation may be a text rewriting operation, and the text processing model may be a text rewriting model commonly used in the related art. An input of the text rewriting model is the first original text. The first original text that needs to be polished is inputted into the model. The text rewriting model analyzes the text to identify errors and opportunities for improvement. The text rewriting model provides improvement suggestions, including, but not limited to, grammatical errors, spelling errors, punctuation errors, and style suggestions, and corrects the first original text based on these improvement suggestions, to obtain the first integrated text.

Operation 102: Concatenate the first integrated text and the first original text, to obtain a concatenated text.

FIG. 3B is a schematic flowchart 1 of an artificial intelligence-based text processing method according to an embodiment of this application. In some embodiments, operation 102 in FIG. 3A may be implemented through operation 1021 and operation 1022 shown in FIG. 3B, which are described in detail below.

Operation 1021: Obtain a concatenation template.

In an example, the concatenation template may be set as required. For example, for the first original text “We're heading to Room 502 for a meeting shortly.” and the first integrated text “We'll be meeting in Room 502 shortly.”, the concatenation template is “Input Text: XXXXX\n Rewrite Text: YYYYY”, where XXXXX is text content “We're heading to Room 502 for a meeting shortly” of the first original text, YYYYY corresponds to text content “We'll be meeting in Room 502 shortly” of the first integrated text, and \n represents a form separator, which may be a hard return, a soft return, or the like. This is not limited herein in this application.

Operation 1022: Concatenate the first original text and the first integrated text based on the concatenation template, to obtain the concatenated text.

In an example, based on the concatenation template “Input Text: XXXXX\n Rewrite Text: YYYYY,”, the first original text “We're heading to Room 502 for a meeting shortly.” and the first integrated text “We'll be meeting in Room 502 shortly” are concatenated, to obtain the concatenated text “Input Text: We're heading to Room 502 for a meeting shortly \n Rewrite Text: We'll be meeting in Room 502 shortly”.

By setting the concatenation template, the first original text and the first integrated text are concatenated into a single entity, serving as the concatenated text for subsequent evaluation, enabling an evaluation model to perform feature extraction only once in a single evaluation process, thereby improving an evaluation speed of text processing quality evaluation.

Still refer to FIG. 3A. Operation 103: Perform multi-dimensional evaluation on the concatenated text, to obtain an evaluation result corresponding to each dimension.

In an example, the multi-dimensional evaluation includes at least two of the following: semantic evaluation, grammatical evaluation, and formatting evaluation. The semantic evaluation refers to evaluating whether semantics of the first integrated text and the first original text are consistent, for example, whether any modifications, additions, or deletions have been made to the content of the first original text. The grammatical evaluation refers to evaluating whether an expression of the first integrated text is accurate, for example, whether spelling errors or grammatical errors are present in the first integrated text. The formatting evaluation refers to evaluating whether formatting of the first integrated text is proper, for example, whether formatting issues such as improper paragraphing and line breaks are present in the first integrated text. The three evaluation perspectives simulate three evaluation perspectives in a manual evaluation process. In an actual application, other evaluation perspectives may be introduced as required to evaluate text processing quality. This is not limited herein in this application.

FIG. 3C is a schematic flowchart 2 of an artificial intelligence-based text processing method according to an embodiment of this application. In some embodiments, the formatting evaluation in operation 103 in FIG. 3A may be implemented through operation 1031 to operation 1033 shown in FIG. 3C, which are described in detail below.

Operation 1031: Perform text vectorization on each character or word in the concatenated text, to obtain a text vector representation of each character or word, and concatenate the text vector representations of a plurality of characters or words into a concatenated text vector representation. Text vectorization converts text into numerical vectors, differing significantly between character-based systems (like Chinese/Kanji) and alphabetic systems (like English). Alphabet systems focus on words, requiring smaller vocabularies and capturing phonetic information. Embodiments of the present application provides technical solutions for both the character-based systems (like Chinese/Kanji) and alphabetic systems (like English) by focusing on either the characters (for a character-based system), letters, or the words (for an alphabetic system) inputted by the user when performing text vectorization. In certain embodiments, a character, a letter, or a word may be used interchangeably to describe the text vectorization. The specific choice of the term used should be understood based on the language system described.

In some embodiments, in operation 1031, the performing text vectorization on each character or word in the concatenated text, to obtain a text vector representation of each character or word may be implemented in the following manner: performing the following processing on each character or word: performing word vectorization on the character or word, to obtain a word vector representation of the character or word; performing sentence vectorization on the character or word based on a sentence to which the character or word belongs, to obtain a sentence vector representation of the character or word, the sentence being from the concatenated text; performing position vectorization on the character or word based on a position of the character or word in the concatenated text, to obtain a position vector representation of the character or word; and fusing the word vector representation, the sentence vector representation, and the position vector representation that correspond to the character or word, to obtain a text vector representation corresponding to the character or word.

In an example, for the concatenated text “Input Text: We're heading to Room 502 for a meeting shortly \n Rewrite Text: We'll be meeting in Room 502 shortly”, the input text herein is the first original text, and the rewrite text herein is the first integrated text. Formatting is first performed on the concatenated text, to obtain a concatenated text form of [CLS] Input Text: We're heading to Room 502 for a meeting shortly \n Rewrite Text: We'll be meeting in Room 502 shortly [EOS], where [CLS] is a text start token, and [EOS] is a text end token. Word vectorization is performed on each word in the concatenated text format, to obtain a word vector representation of the word. For example, a word vector representation of a word A in the input text is the same as a word vector representation of a word A in the rewrite text, and the word vector representation of the word A in the input text is different from a word vector representation of a word B in the input text. For each word, a corresponding sentence vector representation is obtained according to its sentence source. The word A in the input text and the word A in the rewrite text have different sentence vector representations. The word A in the input text and the word B in the input text have the same sentence vector representation. The first word A and the third word A in the input text have different position vector representations. The first word A in the input text and the first word A in the rewrite text have the same position vector representation.

In an example, in natural language processing (NLP), position vectorization is implemented through position embedding, is a technology configured for introducing positional information of elements in a sequence, and is usually used together with word embedding. Position embedding is usually implemented by learning an embedding matrix having the same length as that of the sequence. Each row in the matrix corresponds to an embedding vector of a specific position in the sequence. The embedding vector is added to a corresponding word embedding vector to form a complete input representation, enabling a transformer to learn the positional information. An embedding vector of a position i is generated by using sine and cosine functions in different dimensions. The introduction of the position embedding enables a transformer model to process sequential data without sacrificing its parallel processing capability.

The text vector representation of each character or word is determined based on the character or word, the sentence source of the character or word, and the position of the character in the concatenated text, and information of each character is accurately expressed, to ensure that information in features obtained through subsequent feature extraction is accurate and abundant, thereby ensuring accuracy of subsequent evaluation.

Operation 1032: Perform formatting feature extraction on the concatenated text vector representation, to obtain a formatting feature corresponding to the concatenated text.

In some embodiments, operation 1032 may be implemented in the following manner: performing the following processing on a text vector representation of each character or word in the concatenated text vector representation: performing formatting feature extraction on the text vector representation of the character or word when a character or word corresponding to the text vector representation of the character or word is the first character or word of the concatenated text, to obtain a character or word formatting feature of the character or word; or performing formatting feature extraction on the text vector representation of the character or word and the preceding character or word positioned before the character or word in the concatenated text when a character or word corresponding to the text vector representation of the character or word is not the first character or word of the concatenated text, to obtain a character or word formatting feature of the character or word; and using the character or word formatting feature of the last character or word in the concatenated text as the formatting feature of the concatenated text.

In an example, using an example in which [CLS] Input Text: We're heading to Room 502 for a meeting shortly \n Rewrite Text: We'll be meeting in Room 502 shortly [EOS], for the word “Input”, formatting feature extraction is only performed on the word “Input”, and the word formatting feature of the word is only the word formatting feature of the word “Input”. For the word “Text”, formatting feature extraction is performed on the word “Text” and the word “Input”, to obtain the word formatting feature of the word “Text”. The rest can be deduced by analogy. Corresponding to the last word (that is, corresponding to the word at the [EOS] position) “shortly”, formatting feature extraction is performed on the text vector representation of the word “shortly” and the preceding word positioned before the word “shortly” in the concatenated text, to obtain the word formatting feature of the word “shortly”, and the word formatting feature of the word “shortly” is used as the formatting feature of the concatenated text. The performing formatting feature extraction on the concatenated text vector representation, to obtain a formatting feature corresponding to the concatenated text is implemented by invoking a formatting evaluation model.

The formatting feature extraction is performed on each character or word, and the character or word formatting feature of the last character including the character or word formatting features of all the characters or words is used as the formatting feature of the concatenated text, to ensure that information of the formatting feature is accurate and abundant, to ensure accuracy of subsequent evaluation.

Operation 1033: Perform first mapping on the formatting feature, to obtain a formatting evaluation result.

In some embodiments, operation 1033 may be implemented in the following manner: performing multi-layer perception processing on the formatting feature, to obtain a predicted score value corresponding to the concatenated text; performing normalization on the predicted score value based on an activation function, to obtain a formatting evaluation score; and using the formatting evaluation score as the formatting evaluation result.

In an example, a formatting scoring network in the formatting evaluation model is invoked to perform the first mapping on the formatting feature. The formatting scoring network includes a first multi-layer perceptron (MLP) and a first normalization layer. Multi-layer perception processing is performed on the formatting feature by using the first multi-layer perceptron, to obtain a predicted formatting score value corresponding to the concatenated text. The predicted formatting score value is a real number, which is not convenient for representing an evaluation result. Therefore, the predicted formatting score value is mapped to a formatting evaluation score with a value range of [0, 1] through an activation function in the first normalization layer, such as a Sigmoid activation function, serving as the formatting evaluation result of the concatenated text.

In an example, the multi-layer perceptron (MLP) is a feedforward artificial neural network, which includes at least three layers of nodes: an input layer, one or more hidden layers, and an output layer. Each node (also referred to as a neuron) is connected to nodes in a next layer through connection weights, and each connection weight affects signal transmission. The following is a detailed description of the multi-layer perceptron. The input layer receives input data, each input node representing one feature in a data set. The hidden layers include one or more layers. Each layer includes several neurons. The layers do not directly interact with external input or output, but are configured for internal data processing. A quantity of the hidden layers and a quantity of the neurons in each hidden layer are hyperparameters, which need to be adjusted according to a specific problem. For the output layer, a quantity of neurons in the output layer depends on a specific task. For example, for a classification problem, a quantity of nodes in the output layer is usually the same as a quantity of categories, each node representing a predicted probability of one category.

The first mapping is performed on the formatting feature by invoking the multi-layer perceptron and the activation function, to obtain a formatting evaluation result with a value range of [0, 1], to represent formatting quality of the concatenated text. Formatting quality of text processing can be evaluated, and text processing quality can be evaluated with reference to other evaluation perspectives, thereby improving accuracy of text processing evaluation.

The text vectorization is performed on each character or word in the concatenated text, to obtain the text vector representation of each character or word; and the text vector representations of the plurality of the characters or words are concatenated into the concatenated text vector representation, thereby enriching hidden layer information in the concatenated text vector representation. The formatting feature extraction is performed on the concatenated text vector representation, to obtain the formatting feature corresponding to the concatenated text. The first mapping is performed on the formatting feature, to obtain the formatting evaluation result, thereby ensuring that a feature configured for representing formatting quality of the concatenated text includes abundant information, and further improving accuracy of text processing quality evaluation.

In some embodiments, the semantic evaluation in operation 103 may be implemented in the following manner: performing text vectorization on each character or word in the concatenated text, to obtain a text vector representation of each character or word, and concatenating the text vector representations of a plurality of characters or words into a concatenated text vector representation; invoking a semantic evaluation model to perform semantic feature extraction on the concatenated text vector representation, to obtain a semantic feature corresponding to the concatenated text; and invoking a semantic scoring network in the semantic evaluation model to perform second mapping on the semantic feature, the semantic scoring network in the semantic evaluation model performing the second mapping on the semantic feature, and the semantic scoring network including a second multi-layer perceptron and a second normalization layer. The first multi-layer perception processing is performed on the semantic feature by using the second multi-layer perceptron, to obtain a predicted semantic score value corresponding to the concatenated text. The predicted semantic score value is a real number. The predicted semantic score value is mapped to a semantic evaluation score with a value range of [0, 1] through an activation function in the second normalization layer, serving as a semantic evaluation result of the concatenated text.

In some embodiments, the grammatical evaluation in operation 103 may be implemented in the following manner: performing text vectorization on each character or word in the concatenated text, to obtain a text vector representation of each character or word, and concatenating the text vector representations of a plurality of characters or words into a concatenated text vector representation; invoking a grammatical evaluation model to perform grammatical feature extraction on the concatenated text vector representation, to obtain a grammatical feature corresponding to the concatenated text; and invoking a grammatical scoring network in the grammatical evaluation model to perform third mapping on the grammatical feature, the grammatical scoring network including a second multi-layer perceptron and a second normalization layer. Second multi-layer perception processing is performed on the grammatical feature by using the second multi-layer perceptron, to obtain a predicted grammatical score value corresponding to the concatenated text. The predicted grammatical score value is a real number. The predicted grammatical score value is mapped to a grammatical evaluation score with a value range of [0, 1] through an activation function in the second normalization layer, serving as a grammatical evaluation result of the concatenated text.

The text vectorization is performed on each character or word in the concatenated text, to obtain the text vector representation of each character or word; and the text vector representations of the plurality of the characters or words are concatenated into the concatenated text vector representation, thereby enriching hidden layer information in the concatenated text vector representation. The semantic feature extraction and the grammatical feature extraction are performed on the concatenated text vector representation, to obtain the semantic feature and the grammatical feature that correspond to the concatenated text. The semantic feature and the grammatical feature are mapped to obtain the evaluation result, thereby ensuring that a feature configured for representing semantics and grammar of the concatenated text includes abundant information, and further improving accuracy of text processing quality evaluation.

Still refer to FIG. 3A. Operation 104: Fuse the evaluation results of at least two of the dimensions, to obtain a corrected evaluation result of the first integrated text.

FIG. 3D is an exemplary schematic flowchart 3 of an artificial intelligence-based text processing method according to an embodiment of this application. In some embodiments, operation 104 in FIG. 3A may be implemented through operation 1041 and operation 1042 shown in FIG. 3D, which are described in detail below.

Operation 1041: Obtain a weight combination adapted to an evaluation requirement, the weight combination including a first weight corresponding to the semantic evaluation result, a second weight corresponding to the grammatical evaluation result, and a third weight corresponding to the formatting evaluation result.

In an example, the weight combination adapted to an evaluation requirement is set. For example, evaluation needs to be performed according to three perspectives, namely, semantics, grammar, and formatting. The first weight corresponding to the semantic evaluation result, the second weight corresponding to the grammatical evaluation result, and the third weight corresponding to the formatting evaluation result are set. A sum of the first weight, the second weight, and the third weight is 1. Each weight may be set according to an actual requirement. For example, if actual evaluation has the highest requirement on semantics, a value of the first weight is the largest value of the weights. In addition, the semantic evaluation result and the grammatical evaluation result may be obtained through the related art, or may be obtained through the method in operation 103. Details are not described herein again.

Operation 1042: Perform weighted summation on the semantic evaluation result, the grammatical evaluation result, and the formatting evaluation result based on the weight combination, to obtain the corrected evaluation result of the first integrated text.

In an example, the semantic evaluation result is 0.7, the grammatical evaluation result is 0.99, and the formatting evaluation result is 0.99. A score fusion module is invoked to perform weighted summation on the formatting score, the semantic score, and the grammatical score, to obtain the corrected evaluation result of the first integrated text. The corrected evaluation result=the first weight x the semantic evaluation result+the second weight × the grammatical evaluation result+the third weight × the formatting evaluation result=0.35×0.7+0.35×0.99+0.3×0.99=0.89. The first weight+the second weight+the third weight=0.35+0.35+0.3=1.

A corresponding weight is set according to an actual requirement, and weighted addition is performed with reference to the evaluation results of at least two of the evaluation perspectives, to obtain a corrected evaluation perspective corresponding to the first integrated text. The text processing quality can be evaluated according to an actual requirement, to provide an accurate basis for the subsequent selection for the optimal text processing result. In addition, manual evaluation is simulated to evaluate the text processing quality, thereby improving accuracy of text processing quality evaluation.

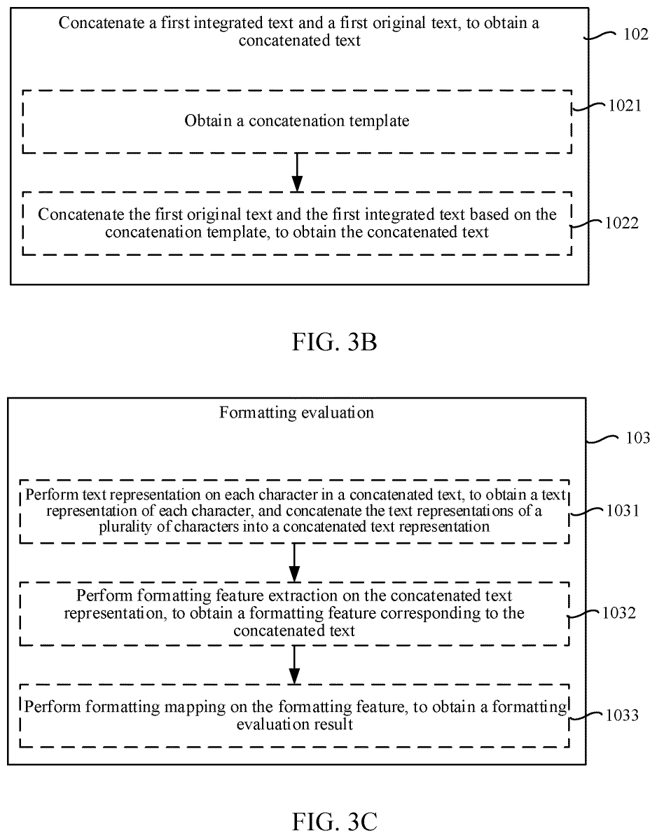

FIG. 4 is a schematic flowchart of an evaluation model training method according to an embodiment of this application. In some embodiments, before operation 103 is performed, operation 201 to operation 205 shown in FIG. 4 may further be performed, which are described in detail below.

Operation 201: Obtain a second integrated text.

In an example, the second integrated text is obtained by correcting a second original text. This operation is the same as operation 101. Details are not described herein again.

Operation 202: Concatenate the second integrated text and the second original text, to obtain a concatenated text sample.

In an example, this operation is the same as operation 102. Details are not described herein again.

Operation 203: Perform forward propagation on the concatenated text sample in a pre-trained model, to obtain a predicted evaluation result of the concatenated text sample in a target dimension.

In some embodiments, operation 203 may be implemented in the following manner: invoking the pre-trained model to perform the following operations on the concatenated text sample: performing text vectorization on each sample character or word in the concatenated text sample, to obtain a sample text vector representation of each sample character or word, and concatenating the sample text vector representations of a plurality of sample characters or words into a concatenated text sample representation; performing feature extraction corresponding to the target dimension on the concatenated text sample representation, to obtain a text sample feature in the target dimension; performing multi-layer perception processing on the text sample feature, to obtain a sample predicted score value corresponding to the concatenated text sample in the target dimension; performing normalization on the sample predicted score value based on an activation function, to obtain a sample evaluation score, a value range of the sample evaluation score being not less than 0 and not greater than 1; and using the sample evaluation score as a predicted evaluation result of the concatenated text sample in the target dimension.

In an example, when the target dimension is semantic evaluation, the performing forward propagation on the concatenated text sample in a pre-trained model in this embodiment of this application actually refers to performing semantic evaluation on the concatenated text sample, to obtain a semantic evaluation result. When the target dimension is grammatical evaluation, the performing forward propagation on the concatenated text sample in a pre-trained model in this embodiment of this application actually refers to performing grammatical evaluation on the concatenated text sample, to obtain a grammatical evaluation result. When the target dimension is formatting evaluation, the performing forward propagation on the concatenated text sample in a pre-trained model in this embodiment of this application actually refers to performing formatting evaluation on the concatenated text sample, to obtain a formatting evaluation result. Specific implementations of the foregoing evaluation are the same as those described above, and a difference lies only in that the processing object is the concatenated text sample. In an example, the target dimension is from the plurality of dimensions. The text vectorization, the feature extraction, the multi-layer perception processing, and the normalization herein are the same as those in operation 103. A difference only lies in that the used evaluation model is the pre-trained model. Details are not described herein again.

The pre-trained model is invoked to perform the text vectorization, the feature extraction, the multi-layer perception processing, and the normalization on the concatenated text sample based on the target dimension, so that the pre-trained model obtains evaluation knowledge and capabilities corresponding to the target dimension, to be applied to a subsequent text processing quality evaluation task, thereby improving an evaluation speed.

Operation 204: Obtain an actual evaluation result of the concatenated text sample in the target dimension.

In some embodiments, operation 204 may be implemented in the following manner: determining the value 1 as the actual evaluation result of the concatenated text sample in the target dimension when the second original text and the second integrated text have a positive sample relationship in the target dimension; or determining the value 0 as the actual evaluation result of the concatenated text sample in the target dimension when the second original text and the second integrated text have a negative sample relationship in the target dimension.

In an example, 1 is determined as the actual evaluation result of the concatenated text sample in the target dimension when the second original text and the second integrated text have a positive sample relationship in the target dimension; or 0 is determined as the actual evaluation result of the concatenated text sample in the target dimension when the second original text and the second integrated text have a negative sample relationship in the target dimension.

The actual evaluation results of positive and negative samples in the target dimension are set as a parameter tuning basis in a model training process, to perform parameter tuning on the evaluation model, thereby improving accuracy of the evaluation model, and improving accuracy of text processing quality evaluation.

Operation 205: Determine a loss function based on the predicted evaluation result and the actual evaluation result in the target dimension, and update the pre-trained model based on the loss function, to obtain the evaluation model.

In an example, the evaluation model is configured for performing evaluation of the target dimension on the concatenated text sample. For example, when the target dimension is formatting evaluation, a formatting loss function is determined based on a predicted formatting evaluation result and an actual formatting evaluation result, and the pre-trained model is updated based on the formatting loss function. For example, parameter tuning and updating are performed on parameters of a language model network and a multi-layer perceptron in the pre-trained model, to obtain a formatting evaluation model.

In an example, when the target dimension is a formatting dimension, positive and negative samples corresponding to the formatting evaluation are collected as formatting evaluation training samples. The second original text in the formatting evaluation training samples and the corresponding second integrated text are concatenated, to obtain a formatting evaluation concatenated text sample. Text vectorization is performed on each sample character or word in the formatting evaluation concatenated text sample, to obtain a sample text vector representation of each sample character or word. In addition, the sample text vector representations of a plurality of sample characters or words are concatenated into a formatting evaluation concatenated text sample representation. A first pre-trained model is invoked to perform formatting feature extraction on the formatting evaluation concatenated text sample representation, to obtain a text sample formatting feature in the formatting dimension. Multi-layer perception processing is performed on the text sample formatting feature, to obtain a sample predicted formatting score value corresponding to the formatting evaluation concatenated text sample in the formatting dimension. Normalization is performed on the sample predicted formatting score value based on an activation function, to obtain a sample formatting evaluation score. The sample formatting evaluation score is used as a predicted formatting evaluation result of the formatting evaluation concatenated text sample in the formatting dimension. According to positive and negative sample attributes of the formatting evaluation training samples, an actual formatting evaluation result of the formatting evaluation concatenated text sample in the formatting dimension is determined. Based on the predicted formatting evaluation result and the actual formatting evaluation result, a formatting loss function is determined. The first pre-trained model is updated based on the formatting loss function, to obtain the formatting evaluation model.

In an example, when the target dimension is a semantic dimension, positive and negative samples corresponding to the semantic evaluation are collected as semantic evaluation training samples. The second original text in the semantic evaluation training samples and the corresponding second integrated text are concatenated, to obtain a semantic evaluation concatenated text sample. Text vectorization is performed on each sample character or word in the semantic evaluation concatenated text sample, to obtain a sample text vector representation of each sample character or word. In addition, the sample text vector representations of a plurality of sample characters or words are concatenated into a semantic evaluation concatenated text sample representation. A second pre-trained model is invoked to perform semantic feature extraction on the semantic evaluation concatenated text sample representation, to obtain a text sample semantic feature in the semantic dimension. Multi-layer perception processing is performed on the text sample semantic feature, to obtain a sample predicted semantic score value corresponding to the semantic evaluation concatenated text sample in the semantic dimension. Normalization is performed on the sample predicted semantic score value based on an activation function, to obtain a sample semantic evaluation score. The sample semantic evaluation score is used as a predicted semantic evaluation result of the semantic evaluation concatenated text sample in the semantic dimension. According to positive and negative sample attributes of the semantic evaluation training samples, an actual semantic evaluation result of the semantic evaluation concatenated text sample in the semantic dimension is determined. Based on the predicted semantic evaluation result and the actual semantic evaluation result, a semantic loss function is determined. The second pre-trained model is updated based on the semantic loss function, to obtain the semantic evaluation model.

In an example, when the target dimension is a grammatical dimension, positive and negative samples corresponding to the grammatical evaluation are collected as grammatical evaluation training samples. The second original text in the grammatical evaluation training samples and the corresponding second integrated text are concatenated, to obtain a grammatical evaluation concatenated text sample. Text vectorization is performed on each sample character or word in the grammatical evaluation concatenated text sample, to obtain a grammatical text vector representation of each sample character or word. In addition, the sample text vector representations of a plurality of sample characters or words are concatenated into a grammatical evaluation concatenated text sample representation. A third pre-trained model is invoked to perform grammatical feature extraction on the grammatical evaluation concatenated text sample representation, to obtain a text sample grammatical feature in the grammatical dimension. Multi-layer perception processing is performed on the text sample grammatical feature, to obtain a sample predicted grammatical score value corresponding to the grammatical evaluation concatenated text sample in the grammatical dimension. Normalization is performed on the sample predicted grammatical score value based on an activation function, to obtain a sample grammatical evaluation score. The sample grammatical evaluation score is used as a predicted grammatical evaluation result of the grammatical evaluation concatenated text sample in the grammatical dimension. According to positive and negative sample attributes of the grammatical evaluation training samples, an actual grammatical evaluation result of the grammatical evaluation concatenated text sample in the grammatical dimension is determined. Based on the predicted grammatical evaluation result and the actual grammatical evaluation result, a grammatical loss function is determined. The third pre-trained model is updated based on the grammatical loss function, to obtain the grammatical evaluation model.

Pre-training is performed on the pre-trained model, to obtain an evaluation model applicable to the target dimension, to be applied to a text processing quality evaluation task, thereby improving an evaluation speed and accuracy of text processing quality evaluation.

An application of this embodiment of this application in an actual text rewriting application scenario is described below.

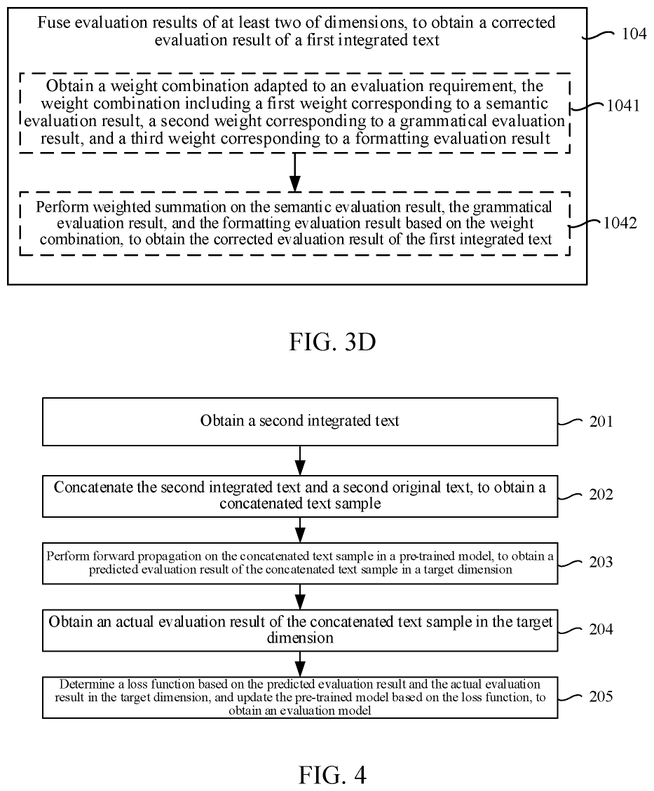

FIG. 5A is a schematic diagram of a text rewriting interface for rewriting in semantic and grammatical dimensions according to an embodiment of this application. On a product side of a text rewriting application, when entering an original text in an input box of an input method, a user invokes an optimization expression function, and a recommendation interface of the input method displays a rewrite text corresponding to the original text. The user clicks/taps a “Use” function item, so that the original text in the input box can be replaced with the rewrite text. A text rewriting function may polish semantics and grammar of the original text. As shown in FIG. 5A, when entering an original text “Oh, by the way-did you have dinner yet? I was actually planning to ask if you wanted to grab a meal tomorrow.” in the input box, the user invokes the optimization expression function, and the recommendation interface of the input method displays a rewrite text A corresponding to the original text “By the way, have you eaten today? I was actually planning to ask you out for a meal tomorrow”. The user clicks/taps the “Use” function item, so that the original text a in the input box can be replaced with the rewrite text A. The user clicks/taps a “Send” function item, so that the rewrite text A can be sent as an instant message. In addition, the text rewriting function may further polish semantics, grammar, and formatting of the original text. FIG. 5B is a schematic diagram of a text rewriting interface for rewriting in semantic, grammatical, and formatting dimensions according to an embodiment of this application. As shown in FIG. 5B, when entering an original text b “Afternoon Management Meeting: Recent Store Management Status (Products, Performance, Team)-Issues and Areas for Optimization; Individual Work Report (Summary and Action Plan); June Cost Analysis; and Discussion on Renewing the “Materials Manager” Service” in an input box, a user invokes an optimization expression function, and a recommendation interface of an input method displays a rewrite text B corresponding to the original text b “Afternoon Management Meeting:
1. Key issues and areas for optimization regarding recent store management (covering products, performance, and team).
2. Individual work reports (summary and future plans).
3. Discussion on the June cost analysis and the renewal of the “Materials Manager” service.”

The user clicks/taps a “Use” function item, so that the content in the input box, that is, the original text b, can be replaced with the rewrite text B. If the user needs to adjust the rewrite text B, the rewrite text B can be adjusted in the input box. When the user clicks/taps a “Send” function item, the rewrite text in the input box can be sent as an instant message.

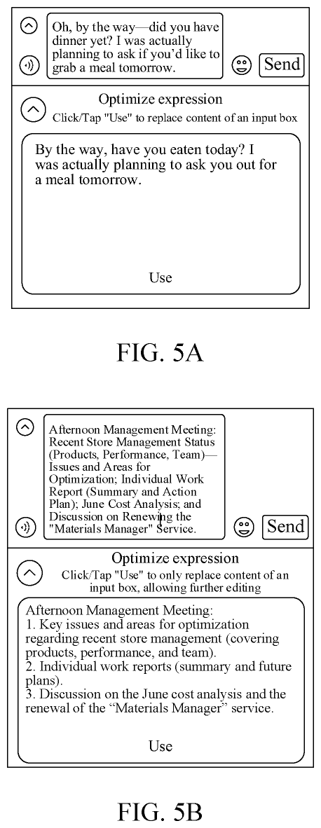

FIG. 6 is an overall architectural diagram of a text rewriting evaluation solution according to an embodiment of this application. As shown in FIG. 6, an original text Afternoon Management Meeting: Recent Store Management Status (Products, Performance, Team)-Issues and Areas for Optimization; Individual Work Report (Summary and Action Plan); June Cost Analysis; and Discussion on Renewing the “Materials Manager” Service” and a rewrite text “Afternoon Management Meeting:
1. Key issues and areas for optimization regarding recent store management (covering products, performance, and team).
2. Individual work reports (summary and future plans).
3. Discussion on the June cost analysis and the renewal of the “Materials Manager” service.”
are obtained. The original text and the rewrite text are inputted into a text rewriting quality evaluation architecture. The text rewriting quality evaluation architecture includes a formatting evaluation model, a semantic evaluation model, a grammatical evaluation model, and a score fusion module. The three evaluation models correspond to three evaluation perspectives, namely, a formatting perspective, a semantic perspective, and a grammatical perspective in manual evaluation. Each evaluation model outputs a score whose value is between 0 and 1. For details, refer to Table 1.

TABLE 1
Evaluation perspective analysis table

| Evaluation | | Corresponding | Output |
|---|---|---|---|
| perspective | Description | model | score |
| Semantic perspective | Whether semantics of a rewrite | Semantic | Semantic |
| (Whether semantics | text and those of an original text | evaluation | score |
| are consistent) | are consistent is evaluated. | model | |
| | Whether to modify, add, or delete | | |
| | fact content of importance. | | |
| Grammatical perspective | Whether a rewrite text has | Grammatical | Grammatical |
| (Whether grammar | spelling errors or grammatical | evaluation | score |
| is accurate) | errors is evaluated. | model | |
| Formatting perspective | Whether formatting of a rewrite | Formatting | Formatting |
| (Whether formatting | text is proper, including proper | evaluation | score |
| is proper) | paragraphing and line breaks, is | model | |
| | evaluated. | | |

Still refer to FIG. 6. The formatting evaluation model scores and evaluates the original text and the rewrite text from the formatting perspective, to obtain a formatting score of 0.99. The semantic evaluation model scores and evaluates the original text and the rewrite text from the semantic perspective, to obtain a semantic score of 0.7 (in the “Product, Performance, Team” in the original text, only the “Product Performance” is included in the rewrite text, and the “Team” is omitted in the rewrite text, and therefore, the score from the semantic perspective is low, and is 0.7). The grammatical evaluation model scores and evaluates the original text and the rewrite text from the grammatical perspective, to obtain a grammatical score of 0.99. The score fusion module performs weighted addition on the formatting score, the semantic score, and the grammatical score, to obtain an evaluation score of 0.89. The evaluation score=a first weight x the semantic score+a second weight × the grammatical score+a third weight × the formatting score=0.35×0.7+0.35×0.99+0.3×0.99=0.89, where the first weight+the second weight +the third weight=0.35+0.35+0.3=1. The values of the first weight, the second weight, and the third weight may be set according to an actual requirement. For example, in an actual application scenario, higher accuracy of grammar is required, and the third weight may be correspondingly increased.

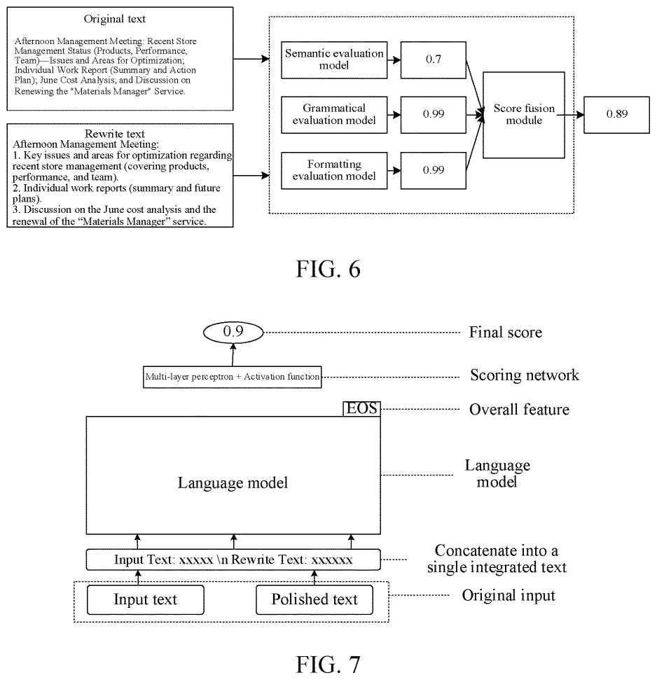

FIG. 7 is a schematic structural diagram of an evaluation model according to an embodiment of this application. A formatting evaluation model, a semantic evaluation model, and a grammatical evaluation model have the same structure, and are sentence classification models based on large language models. The foregoing three models are collectively referred to as the evaluation model. The structure of the evaluation model is shown in FIG. 7. The evaluation model includes a language model configured for feature extraction and a scoring network configured for scoring. In a scoring process, an original input is an input text (that is, a first original text) and a rewrite text (that is, a first integrated text), and the input text and the rewrite text are concatenated into a single integrated text (that is, a concatenated text) “Input Text: XXXXX\n Rewrite Text: YYYYY”. The integrated text is inputted into the language model of the evaluation model, where the language model performs feature extraction on the integrated text, to obtain an overall feature corresponding to a target dimension. The overall feature is inputted into the scoring network, and is scored by a multi-layer perceptron and an activation function in the scoring network, to obtain a final score of 0.9. A type of the overall feature depends on the type of the evaluation model. For example, when the formatting evaluation model is used to perform feature extraction on the integrated text, the language model in the formatting evaluation model performs feature extraction on the integrated text, and the obtained overall feature is a formatting feature. The overall feature is inputted into a formatting scoring network in the formatting evaluation model. A multi-layer perceptron and an activation function in the formatting scoring network perform first mapping on the formatting feature, to obtain a final formatting score (that is, a formatting evaluation result). When the semantic evaluation model is used to perform feature extraction on the integrated text, the language model in the semantic evaluation model performs semantic feature extraction on the integrated text, and the obtained overall feature is a semantic feature. The semantic feature is inputted into a semantic scoring network in the semantic evaluation model. A multi-layer perceptron and an activation function in the semantic scoring network perform second mapping on the semantic feature, to obtain a final semantic score (that is, a semantic evaluation result). When the grammatical evaluation model is used to perform grammatical feature extraction on the integrated text, the language model in the grammatical evaluation model performs grammatical feature extraction on the integrated text, and the obtained overall feature is a grammatical feature. The grammatical feature is inputted into a grammatical scoring network in the grammatical evaluation model. A multi-layer perceptron and an activation function in the grammatical scoring network perform third mapping on the grammatical feature, to obtain a final grammatical score (that is, a grammatical evaluation result). The process is described in detail below by using a single evaluation model as an example.

For details of an input format of the integrated text inputted into the language model, refer to Table 2.

TABLE 2
Example table of an input format of an integrated text

| Template | Example |
|---|---|
| Original Text | Original Text |
| {INPUT TEXT} | Afternoon Management Meeting: Recent Store Management Status |
| | (Products, Performance, Team)-Issues and Areas for Optimization; |
| | Individual Work Report (Summary and Action Plan); June Cost Analysis; |
| | and Discussion on Renewing the “Materials Manager” Service. |
| Rewrite Text | Rewrite Text |
| {REWRITE TEXT} | Afternoon Management Meeting: |
| | 1. Key issues and areas for optimization regarding recent store |
| | management (covering products, performance, and team). |
| | 2. Individual work reports (summary and future plans). |
| | 3. Discussion on the June cost analysis and the renewal of the “Materials |
| | Manager” service. |

Model calculation for each evaluation model includes the following two stages.

(1) Sentence-level feature extraction: An original input text and a corresponding rewrite text are concatenated into an integrated text, and the integrated text is inputted into the language model. As shown in FIG. 7, the language model is the large language model described above. The language model first processes the integrated text into an integrated text vector representation, and then performs feature extraction on the integrated text vector representation, to obtain an integrated feature H corresponding to the integrated text. The integrated feature H is an output of the last layer of the language model at a position of an end of sequence (EOS) label character or word (that is, an [EOS] label), i.e.,

$$H = LLM ( INPUT TEXT ∖ n REWRITE TEXT )$$

INPUT TEXT is content of the input text, REWRITE TEXT is content of the rewrite text, and LLM (INPUT TEXT \n REWRITE TEXT) is an output of the last layer obtained through feature extraction by the language model, where the input is the integrated text formed by concatenating the input text and the rewrite text.

For example, the input text is ““We're heading to Room 502 for a meeting shortly”, and the rewrite text is “We'll be meeting in Room 502 shortly”. The input text and the rewrite text are concatenated into the integrated text “Input Text: We're heading to Room 502 for a meeting shortly \n Rewrite Text: We'll be meeting in Room 502 shortly”. The integrated text is inputted into the language model of the evaluation model. The language model first performs a word segmentation operation on the integrated text, segments the integrated text into individual tokens or characters or owrds, and generates corresponding special marks such as [CLS] and [EOS] at the start and end of the text. For example, for the integrated text “Input Text: We're heading to Room 502 for a meeting shortly \n Rewrite Text: We'll be meeting in Room 502 shortly”, a form of a word segmentation result of the integrated text is [CLS] “Input Text: We're heading to Room 502 for a meeting shortly \n Rewrite Text: We'll be meeting in Room 502 shortly” [EOS].

The language model performs feature extraction on the word segmentation result of the integrated text. When feature extraction is performed on each character or word in the integrated text, a feature of the character can only be obtained by combining the character or word and a character or word positioned before the character or word. Finally, the feature of the last character or word of the integrated text, that is, a character or word corresponding to a symbol position of [EOS], is used as the integrated feature H of the integrated text. The integrated feature H corresponding to the integrated text is outputted, i.e.,

$$H = LLM ( Input Text : We ' re heading to Room 502 for a meeting shortly \backslash n Rewrite Text : We ' ll be meeting in Room 502 shortly ) .$$

(2) Scoring module: Based on the multi-layer perceptron (MLP) in the scoring network, the integrated feature H is mapped to output an evaluation real number, and an activation function, such as a Sigmoid function. The evaluation real number is processed, and a value between 0 and 1 is outputted as an evaluation score corresponding to the integrated feature, to score the integrated feature of the integrated text, i.e.,

$$the evaluation = Sigmoid ( MLP ( H ) )$$

where MLP (H) is the evaluation real number outputted by the multi-layer perceptron.

In the model training process, the semantic evaluation model, the grammatical evaluation model, and the formatting evaluation model need to be respectively trained. First, corresponding positive and negative samples are respectively collected for different evaluation models. For details of samples corresponding to the semantic evaluation model, refer to Table 3.

TABLE 3
Example table of samples of a semantic evaluation model

| Sample type | Original text | Rewrite text | Description |
|---|---|---|---|
| Positive | We're heading to | We'll be meeting in | |
| sample | Room 502 for a | Room 502 shortly. | |
| | meeting shortly. | | |
| Negative | We're heading to | We'll be meeting in | Changed information: |
| sample | Room 502 for a | Room 501 shortly. | 502 changed to 501 |
| | meeting shortly. | | |
| Negative | We're heading to | We'll be meeting | Information lost: 502 |
| sample | Room 502 for a | shortly. | |
| | meeting shortly. | | |
| Negative | We're heading to | We'll be meeting in | New information: half |
| sample | Room 502 for a | Room 502 in half an | an hour |
| | meeting shortly. | hour. | |

For details of samples corresponding to the grammatical evaluation model, refer to Table 4.

TABLE 4
Example table of samples of a grammatical evaluation model

| Sample type | Original text | Rewrite text | Description |
|---|---|---|---|
| Positive | We're heading to | We'll be meeting in | |
| sample | Room 502 for a | Room 502 shortly | |
| | meeting shotly. | | |
| Negative | We're heading to | We'll be meeting in | The spelling error is |
| sample | Room 502 for a | Room 501 shotly | not corrected: “shotly” |
| | meeting shotly. | | needs to be changed to |
| | | | “shortly”. |
| Negative | We're heading to | We'll be be meeting | Grammatical error: an |
| sample | Room 502 for a | in Room 502 shortly | extra “be” word. |
| | meeting shotly. | | |

For details of samples corresponding to the formatting evaluation model, refer to Table 5.

TABLE 5
Example table of samples of a formatting evaluation model

| Sample type | Original text | Rewrite text | Description |
|---|---|---|---|
| Positive | Bright moonlight shines | Bright moonlight shines | |
| sample | before the window; | before the window; | |
| | I wonder if it is frost upon | I wonder if it is frost upon | |
| | the ground. | the ground. | |
| | I lift my head to gaze at | I lift my head to gaze at the | |
| | the bright moon; | bright moon; | |
| | I bow my head and think | I bow my head and think of | |
| | of my hometown. | my hometown. | |
| Negative | Bright moonlight shines | Bright moonlight shines | The original |
| sample | before the window; | before the window; I | correct formatting |
| | I wonder if it is frost upon | wonder if it is frost upon the | is lost. |
| | the ground. | ground. I lift my head to | |
| | I lift my head to gaze at | gaze at the bright moon; I | |
| | the bright moon; | bow my head and think of | |
| | I bow my head and think | my hometown. | |
| | of my hometown. | | |
| Positive | Afternoon Management | Afternoon Management | After the |
| sample | Meeting: Recent Store | Meeting: | formatting is |
| | Management Status | 1. Key issues and areas for | optimized, the |
| | (Products, Performance, | optimization regarding | original text is |
| | Team)-Issues and Areas | recent store management | clearer and more |
| | for Optimization; | (covering products, | readable. |
| | Individual Work Report | performance, and team). | |
| | (Summary and Action | 2. Individual work reports | |
| | Plan); June Cost | (summary and future | |
| | Analysis; and Discussion | plans). | |
| | on Renewing the | 3. Discussion on the June | |
| | “Materials Manager” | cost analysis and the | |
| | Service. | renewal of the “Materials | |
| | | Manager” service. | |
| Negative | Afternoon Management | Afternoon Management | The formatting is |
| sample | Meeting: Recent Store | Meeting: Recent Store | not properly |
| | Management Status | Management Status | performed, |
| | (Products, Performance, | (Products, Performance, | resulting in poor |
| | Team)-Issues and Areas | Team)-Issues and Areas | readability. |
| | for Optimization; | for Optimization; | |
| | Individual Work Report | Individual Work Report | |
| | (Summary and Action | (Summary and Action | |
| | Plan); June Cost | Plan); June Cost Analysis; | |
| | Analysis; and Discussion | and Discussion on | |
| | on Renewing the | Renewing the “Materials | |
| | “Materials Manager” | Manager” Service. | |
| | Service. | | |

An actual evaluation score (that is, an actual evaluation result in a target dimension) of a positive sample in a training set is 1, and an actual evaluation score of a negative sample is 0. After sufficient training data is collected (at least 10,000 entries per category), model training can be performed. A training process corresponding to an evaluation model is as follows.

First, the original text in the positive sample or the negative sample and the corresponding rewrite text are concatenated according to the correspondence, to obtain a sample integrated text (that is, a concatenated text sample). The sample integrated text includes a positive sample integrated text and a negative sample integrated text, which are inputted into a pre-trained model for processing, to obtain a predicted score. For example, an input text x is: “Input Text: We're heading to Room 502 for a meeting shortly \n Rewrite Text: We'll be meeting in Room 502 shortly”. The word segmentation operation is performed on the text x, the text x is segmented into individual tokens or characters or words, and special marks, respectively [CLS] and [EOS], are added at the start and end of the text. [CLS] indicates the start of the text, and [EOS] indicates the end of the text, resulting in a word segmentation result: [CLS] Input Text: We're heading to Room 502 for a meeting shortly \n Rewrite Text: We'll be meeting in Room 502 shortly [EOS]. Text vector representation is performed on each character or word in the word segmentation result, to obtain a text vector representation corresponding to the text x. Feature extraction is performed on the text vector representation, to obtain a target dimension feature corresponding to the text x. Mapping is performed on the target dimension feature by invoking the multi-layer perceptron and the activation function in the scoring network, to obtain an output y: a predicted evaluation score (that is, a predicted evaluation result). Then, a loss function is calculated based on the predicted evaluation score and the actual evaluation score, and parameters of the pre-trained model and the multi-layer perceptron are updated based on the loss function, to obtain the evaluation model. When the predicted evaluation score is a predicted formatting evaluation score, a formatting loss function is calculated based on the predicted formatting evaluation score and an actual formatting evaluation score. Parameters of a formatting pre-trained model and a formatting multi-layer perceptron are updated based on the formatting loss function, to obtain the formatting evaluation model. When the predicted evaluation score is a predicted semantic evaluation score, a semantic loss function is calculated based on the predicted semantic evaluation score and an actual semantic evaluation score. Parameters of a semantic pre-trained model and a semantic multi-layer perceptron are updated based on the semantic loss function, to obtain the semantic evaluation model. When the predicted evaluation score is a predicted grammatical evaluation score, a grammatical loss function is calculated based on the predicted grammatical evaluation score and an actual grammatical evaluation score. Parameters of a grammatical pre-trained model and a grammatical multi-layer perceptron are updated based on the grammatical loss function, to obtain the grammatical evaluation model.

Finally, 10% of the positive and negative samples are extracted as a test set, and a model test is performed on each evaluation model by using the test set. If testing accuracy is greater than 90%, it is considered that training of the evaluation model is completed.

In the embodiments of this application, related data such as user information is involved. When the embodiments of this application are applied to a specific product or technology, user permission or consent needs to be obtained, and collection, use, and processing of the related data need to comply with related laws, regulations, and standards of related countries and regions.

The following continues to describe an exemplary structure of the artificial intelligence-based text processing apparatus 253 according to this embodiment of this application, implemented as a software module. In some embodiments, as shown in FIG. 2, the software module in the artificial intelligence-based text processing apparatus 253 that is stored in the memory 250 may include: an obtaining module 2531, configured to obtain a first integrated text, the first integrated text being obtained by correcting a first original text; a concatenation module 2532, configured to concatenate the first integrated text and the first original text, to obtain a concatenated text; an evaluation module 2533, configured to perform multi-dimensional evaluation on the concatenated text, to obtain an evaluation result corresponding to each dimension, the multi-dimensional evaluation including at least two of the following: semantic evaluation, grammatical evaluation, and formatting evaluation; and a fusion module 2534, configured to fuse the evaluation results of at least two of the dimensions, to obtain a corrected evaluation result of the first integrated text.

In some embodiments, the concatenation module 2532 is further configured to: obtain a concatenation template; and concatenate the first original text and the first integrated text based on the concatenation template, to obtain the concatenated text.

In some embodiments, the evaluation module 2533 is further configured to: perform formatting feature extraction on the concatenated text vector representation, to obtain a formatting feature corresponding to the concatenated text; and perform first mapping on the formatting feature, to obtain a formatting evaluation result.

In some embodiments, the evaluation module 2533 is further configured to perform the following processing on each character or word: performing word vectorization on the character or word, to obtain a word vector representation of the character or word; performing sentence vectorization on the character or word based on a sentence to which the character or word belongs, to obtain a sentence vector representation of the character or word, the sentence being from the concatenated text; performing position vectorization on the character or word based on a position of the character or word in the concatenated text, to obtain a position vector representation of the character or word; and fusing the word vector representation, the sentence vector representation, and the position vector representation that correspond to the character or word, to obtain a text vector representation corresponding to the character or word.

In some embodiments, the evaluation module 2533 is further configured to perform the following processing on the text vector representation of each character or word in the concatenated text vector representation: performing formatting feature extraction on the text vector representation of the character or word when a character or word corresponding to the text vector representation of the character or word is the first character or word of the concatenated text, to obtain a character or word formatting feature of the character or word; or performing formatting feature extraction on the text vector representation of the character or word and the preceding character or word when a character or word corresponding to the text vector representation of the character or word is not the first character or word of the concatenated text, to obtain a character or word formatting feature of the character or word, the preceding character or word being the character or word in the concatenated text that is positioned before the character or word; and using the character or word formatting feature of the last character or word in the concatenated text as the formatting feature of the concatenated text.

In some embodiments, the evaluation module 2533 is further configured to: perform multi-layer perception processing on the formatting feature, to obtain a predicted score value corresponding to the concatenated text; perform normalization on the predicted score value based on an activation function, to obtain a formatting evaluation score; and use the formatting evaluation score as the formatting evaluation result.

In some embodiments, the evaluation results of at least two of the dimensions include the semantic evaluation result, the grammatical evaluation result, and the formatting evaluation result. The fusion module 2534 is further configured to: obtain a weight combination adapted to an evaluation requirement, the weight combination including a first weight corresponding to the semantic evaluation result, a second weight corresponding to the grammatical evaluation result, and a third weight corresponding to the formatting evaluation result; and perform weighted summation on the semantic evaluation result, the grammatical evaluation result, and the formatting evaluation result based on the weight combination, to obtain the corrected evaluation result of the first integrated text.

In some embodiments, the evaluation module 2533 is further configured to: obtain a second integrated text, the second integrated text being obtained by correcting a second original text; concatenate the second integrated text and the second original text, to obtain a concatenated text sample; perform forward propagation on the concatenated text sample in a pre-trained model, to obtain a predicted evaluation result of the concatenated text sample in a target dimension, the target dimension being from the plurality of dimensions; obtain an actual evaluation result of the concatenated text sample in the target dimension; determine a loss function based on the predicted evaluation result and the actual evaluation result in the target dimension; and update the pre-trained model based on the loss function, to obtain an evaluation model, the evaluation model being configured for performing evaluation of the target dimension on the concatenated text sample.

In some embodiments, the evaluation module 2533 is further configured to: determine the value 1 as the actual evaluation result of the concatenated text sample in the target dimension when the second original text and the second integrated text have a positive sample relationship in the target dimension; or determine the value 0 as the actual evaluation result of the concatenated text sample in the target dimension when the second original text and the second integrated text have a negative sample relationship in the target dimension.

In some embodiments, the evaluation module 2533 is further configured to invoke the pre-trained model to perform the following operations on the concatenated text sample: performing text vectorization on each sample character or word in the concatenated text sample, to obtain a sample text vector representation of each sample character, and concatenating the sample text vector representations of a plurality of sample characters into a concatenated text sample representation; performing feature extraction corresponding to the target dimension on the concatenated text sample representation, to obtain a text sample feature in the target dimension; performing multi-layer perception processing on the text sample feature, to obtain a sample predicted score value corresponding to the concatenated text sample in the target dimension; performing normalization on the sample predicted score value based on an activation function, to obtain a sample evaluation score, a value range of the sample evaluation score being not less than 0 and not greater than 1; and using the sample evaluation score as a predicted evaluation result of the concatenated text sample in the target dimension.

An embodiment of this application provides a computer program product, including computer-executable instructions, the computer-executable instructions being stored in a computer-readable storage medium. A processor of an electronic device reads the computer-executable instructions from the computer-readable storage medium, and the processor executes the computer-executable instructions, so that the electronic device performs the artificial intelligence-based text processing method according to the embodiments of this application.

An embodiment of this application provides a computer-readable storage medium, having computer-executable instructions stored therein. When the computer-executable instructions are executed by a processor, the processor is caused to perform the artificial intelligence-based text processing method according to the embodiments of this application, for example, the artificial intelligence-based text processing method shown in FIG. 3A.

In some embodiments, the computer-readable storage medium may be a memory such as a random access memory (RAM), a read-only memory (ROM), a flash memory, a magnetic surface memory, a compact disc, or a compact disc ROM (CD-ROM), Alternatively, the computer-readable storage medium may be a device including one or any combination of the foregoing memories.

In some embodiments, the computer-executable instructions may be written in a form of a program, software, a software module, a script, or code according to a programming language (including a compiler or interpreter language or a declarative or procedural language) in any form, and may be deployed in any form, including an independent program or a module, a component, a subroutine, or another unit suitable for use in a computing environment.

In an example, the computer-executable instructions may, but do not necessarily, correspond to a file in a file system, may be stored in a part of a file that stores other programs or data, for example, stored in one or more scripts in a hyper text markup language (HTML) document, stored in a single file dedicated to the discussed program, or stored in a plurality of collaborative files (for example, files that store one or more modules, a subprogram, or a code part).

In an example, the computer-executable instructions may be deployed on one electronic device for execution, or executed on a plurality of electronic devices located at one location, or executed on a plurality of electronic devices distributed at a plurality of locations and interconnected via a communication network.

In conclusion, according to the embodiments of this application, corresponding evaluation models are set corresponding to the three manual evaluation perspectives, namely, semantics, grammar, and formatting, so that accuracy of an evaluation effect of the artificial intelligence-based text processing method according to the embodiments of this application is close to that of an evaluation effect of manual evaluation. In addition, automated evaluation is performed by using the language model, and the evaluation speed is greatly improved compared with that of manual evaluation. Through the artificial intelligence-based text processing method according to the embodiments of this application, defects of the text rewriting model can be quickly identified, and scientific guidance for subsequent iteration directions can be provided.

The foregoing descriptions are merely embodiments of this application and are not intended to limit the protection scope of this application. Any modification, equivalent replacement, and improvement made within the spirit and scope of this application are included in the protection scope of this application.

What is claimed is:

1. An artificial intelligence-based text processing method, performed by an electronic device, the method comprising:
obtaining a first integrated text, the first integrated text being obtained by correcting a first original text;
concatenating the first integrated text and the first original text, to obtain a concatenated text;
performing multi-dimensional evaluation on the concatenated text, to obtain an evaluation result corresponding to each dimension, the multi-dimensional evaluation comprising at least two of the following: semantic evaluation, grammatical evaluation, and formatting evaluation; and
fusing the evaluation results of at least two of the dimensions, to obtain a corrected evaluation result of the first integrated text.

2. The method according to claim 1, wherein the concatenating the first integrated text and the first original text, to obtain a concatenated text comprises:
obtaining a concatenation template; and
concatenating the first original text and the first integrated text based on the concatenation template, to obtain the concatenated text.

3. The method according to claim 1, wherein the formatting evaluation comprises:
performing text vectorization on each character or word in the concatenated text, to obtain a text vector representation of each character or word, and concatenating the text vector representations of a plurality of characters or words into a concatenated text vector representation;
performing formatting feature extraction on the concatenated text vector representation, to obtain a formatting feature corresponding to the concatenated text; and
performing first mapping on the formatting feature, to obtain a formatting evaluation result.

4. The method according to claim 3, wherein the performing text vectorization on each character in the concatenated text, to obtain a text vector representation of each character or word comprises:
performing the following processing on each character or word:
performing word vectorization on the character or word, to obtain a word vector representation of the character or word;
performing sentence vectorization on the character or word based on a sentence to which the character or word belongs, to obtain a sentence vector representation of the character or word, the sentence being from the concatenated text;
performing position vectorization on the character or word based on a position of the character or word in the concatenated text, to obtain a position vector representation of the character or word; and
fusing the word vector representation, the sentence vector representation, and the position vector representation that correspond to the character or word, to obtain the text vector representation corresponding to the character or word.

5. The method according to claim 3, wherein the performing formatting feature extraction on the concatenated text vector representation, to obtain a formatting feature corresponding to the concatenated text comprises:
performing the following processing on the text vector representation of each character in the concatenated text vector representation:
performing formatting feature extraction on the text vector representation of the character or worder when a character or worder corresponding to the text vector representation of the character or worder is the first character or worder of the concatenated text, to obtain a character or worder formatting feature of the character or worder; or
performing formatting feature extraction on the text vector representation of the character or worder and the preceding character or worder when a character or worder corresponding to the text vector representation of the character or worder is not the first character or worder of the concatenated text, to obtain a character or worder formatting feature of the character or worder, the preceding character or worder being the character or worder in the concatenated text that is positioned before the character or worder; and
using the character or worder formatting feature of the last character or worder in the concatenated text as the formatting feature of the concatenated text.

6. The method according to claim 3, wherein the performing first mapping on the formatting feature, to obtain a formatting evaluation result comprises:
performing multi-layer perception processing on the formatting feature, to obtain a predicted score value corresponding to the concatenated text; and
performing normalization on the predicted score value based on an activation function, to obtain a formatting evaluation score, and using the formatting evaluation score as the formatting evaluation result.

7. The method according to claim 1, wherein
the semantic evaluation comprises:
performing text vectorization on each character or word in the concatenated text, to obtain a text vector representation of each character or word, and concatenating the text vector representations of a plurality of characters or words into a concatenated text vector representation;
performing semantic feature extraction on the concatenated text vector representation, to obtain a semantic feature corresponding to the concatenated text; and
performing second mapping on the semantic feature, to obtain a semantic evaluation result of the concatenated text; and
the grammatical evaluation comprises:
performing text vectorization on each character or word in the concatenated text, to obtain a text vector representation of each character or word, and concatenating the text vector representations of a plurality of characters or words into a concatenated text vector representation;
performing grammatical feature extraction on the concatenated text vector representation, to obtain a grammatical feature corresponding to the concatenated text; and
performing third mapping on the grammatical feature, to obtain a grammatical evaluation result of the concatenated text.

8. The method according to claim 1, wherein the evaluation results of at least two of the dimensions comprise the semantic evaluation result, the grammatical evaluation result, and the formatting evaluation result, and the fusing the evaluation results of at least two of the dimensions, to obtain a corrected evaluation result of the first integrated text comprises:
obtaining a weight combination adapted to an evaluation requirement, the weight combination comprising a first weight corresponding to the semantic evaluation result, a second weight corresponding to the grammatical evaluation result, and a third weight corresponding to the formatting evaluation result; and
performing weighted summation on the semantic evaluation result, the grammatical evaluation result, and the formatting evaluation result based on the weight combination, to obtain the corrected evaluation result of the first integrated text.

9. The method according to claim 1, further comprising:
obtaining a second integrated text, the second integrated text being obtained by correcting a second original text;
concatenating the second integrated text and the second original text, to obtain a concatenated text sample;
performing forward propagation on the concatenated text sample in a pre-trained model, to obtain a predicted evaluation result of the concatenated text sample in a target dimension, the target dimension being from the plurality of dimensions;
obtaining an actual evaluation result of the concatenated text sample in the target dimension; and
determining a loss function based on the predicted evaluation result and the actual evaluation result in the target dimension, and updating the pre-trained model based on the loss function, to obtain an evaluation model, the evaluation model being configured for performing evaluation of the target dimension on the concatenated text sample.

10. The method according to claim 9, wherein the obtaining an actual evaluation result of the concatenated text sample in the target dimension comprises:
determining the value 1 as the actual evaluation result of the concatenated text sample in the target dimension when the second original text and the second integrated text have a positive sample relationship in the target dimension; or
determining the value 0 as the actual evaluation result of the concatenated text sample in the target dimension when the second original text and the second integrated text have a negative sample relationship in the target dimension.

11. The method according to claim 9, wherein the performing forward propagation on the concatenated text sample in a pre-trained model, to obtain a predicted evaluation result of the concatenated text sample in a target dimension comprises:
invoking the pre-trained model to perform the following operations on the concatenated text sample:
performing text vectorization on each sample character or word in the concatenated text sample, to obtain a sample text vector representation of each sample character or word, and concatenating the sample text vector representations of a plurality of sample characters or words into a concatenated text sample representation;
performing feature extraction corresponding to the target dimension on the concatenated text sample representation, to obtain a text sample feature in the target dimension;
performing multi-layer perception processing on the text sample feature, to obtain a sample predicted score value corresponding to the concatenated text sample in the target dimension;
performing normalization on the sample predicted score value based on an activation function, to obtain a sample evaluation score, a value range of the sample evaluation score being not less than 0 and not greater than 1; and
using the sample evaluation score as the predicted evaluation result of the concatenated text sample in the target dimension.

12. An electronic device, comprising:
a memory, configured to store computer-executable instructions; and
a processor, configured to implement an artificial intelligence-based text processing method, the method comprising:
obtaining a first integrated text, the first integrated text being obtained by correcting a first original text;
concatenating the first integrated text and the first original text, to obtain a concatenated text;
performing multi-dimensional evaluation on the concatenated text, to obtain an evaluation result corresponding to each dimension, the multi-dimensional evaluation comprising at least two of the following: semantic evaluation, grammatical evaluation, and formatting evaluation; and
fusing the evaluation results of at least two of the dimensions, to obtain a corrected evaluation result of the first integrated text.

13. The electronic device according to claim 12, wherein the concatenating the first integrated text and the first original text, to obtain a concatenated text comprises:
obtaining a concatenation template; and
concatenating the first original text and the first integrated text based on the concatenation template, to obtain the concatenated text.

14. The electronic device according to claim 12, wherein the formatting evaluation comprises:
performing text vectorization on each character or word in the concatenated text, to obtain a text vector representation of each character or word, and concatenating the text vector representations of a plurality of characters or words into a concatenated text vector representation;
performing formatting feature extraction on the concatenated text vector representation, to obtain a formatting feature corresponding to the concatenated text; and
performing first mapping on the formatting feature, to obtain a formatting evaluation result.

15. The electronic device according to claim 14, wherein the performing text vectorization on each character in the concatenated text, to obtain a text vector representation of each character or word comprises:
performing the following processing on each character or word:
performing word vectorization on the character or word, to obtain a word vector representation of the character or word;
performing sentence vectorization on the character or word based on a sentence to which the character or word belongs, to obtain a sentence vector representation of the character or word, the sentence being from the concatenated text;
performing position vectorization on the character or word based on a position of the character or word in the concatenated text, to obtain a position vector representation of the character or word; and
fusing the word vector representation, the sentence vector representation, and the position vector representation that correspond to the character or word, to obtain the text vector representation corresponding to the character or word.

16. The electronic device according to claim 14, wherein the performing formatting feature extraction on the concatenated text vector representation, to obtain a formatting feature corresponding to the concatenated text comprises:
performing the following processing on the text vector representation of each character in the concatenated text vector representation:
performing formatting feature extraction on the text vector representation of the character or worder when a character or worder corresponding to the text vector representation of the character or worder is the first character or worder of the concatenated text, to obtain a character or worder formatting feature of the character or worder; or
performing formatting feature extraction on the text vector representation of the character or worder and the preceding character or worder when a character or worder corresponding to the text vector representation of the character or worder is not the first character or worder of the concatenated text, to obtain a character or worder formatting feature of the character or worder, the preceding character or worder being the character or worder in the concatenated text that is positioned before the character or worder; and
using the character or worder formatting feature of the last character or worder in the concatenated text as the formatting feature of the concatenated text.

17. The electronic device according to claim 14, wherein the performing first mapping on the formatting feature, to obtain a formatting evaluation result comprises:
performing multi-layer perception processing on the formatting feature, to obtain a predicted score value corresponding to the concatenated text; and
performing normalization on the predicted score value based on an activation function, to obtain a formatting evaluation score, and using the formatting evaluation score as the formatting evaluation result.

18. The electronic device according to claim 12, wherein the semantic evaluation comprises:
performing text vectorization on each character or word in the concatenated text, to obtain a text vector representation of each character or word, and concatenating the text vector representations of a plurality of characters or words into a concatenated text vector representation;
performing semantic feature extraction on the concatenated text vector representation, to obtain a semantic feature corresponding to the concatenated text; and
performing second mapping on the semantic feature, to obtain a semantic evaluation result of the concatenated text; and
the grammatical evaluation comprises:
performing text vectorization on each character or word in the concatenated text, to obtain a text vector representation of each character or word, and concatenating the text vector representations of a plurality of characters or words into a concatenated text vector representation;
performing grammatical feature extraction on the concatenated text vector representation, to obtain a grammatical feature corresponding to the concatenated text; and
performing third mapping on the grammatical feature, to obtain a grammatical evaluation result of the concatenated text.

19. The electronic device according to claim 12, wherein the evaluation results of at least two of the dimensions comprise the semantic evaluation result, the grammatical evaluation result, and the formatting evaluation result, and the fusing the evaluation results of at least two of the dimensions, to obtain a corrected evaluation result of the first integrated text comprises:
obtaining a weight combination adapted to an evaluation requirement, the weight combination comprising a first weight corresponding to the semantic evaluation result, a second weight corresponding to the grammatical evaluation result, and a third weight corresponding to the formatting evaluation result; and
performing weighted summation on the semantic evaluation result, the grammatical evaluation result, and the formatting evaluation result based on the weight combination, to obtain the corrected evaluation result of the first integrated text.

20. A non-transitory computer-readable storage medium, having computer-executable instructions stored therein, the computer-executable instructions, when executed by a processor, implementing an artificial intelligence-based text processing method, the method comprising:
obtaining a first integrated text, the first integrated text being obtained by correcting a first original text;
concatenating the first integrated text and the first original text, to obtain a concatenated text;
performing multi-dimensional evaluation on the concatenated text, to obtain an evaluation result corresponding to each dimension, the multi-dimensional evaluation comprising at least two of the following: semantic evaluation, grammatical evaluation, and formatting evaluation; and
fusing the evaluation results of at least two of the dimensions, to obtain a corrected evaluation result of the first integrated text.
